(19) United States
(12) Patent Application Publication
(10) Pub. No.: US 2026/0001210 A1
(43) Pub. Date: Jan. 1, 2026

(54) MECHANICALLY DRIVEN AND BATTERY POWERED EXTENSION POLE

(71) Applicant: Lenardo Bartholomew Youmans, Cary, NC (US)

(72) Inventor: Lenardo Bartholomew Youmans, Cary, NC (US)

(21) Appl. No.: 18/755,875

(22) Filed: Jun. 27, 2024

(51) Int. Cl. B25G 1/04

(52) U.S. Cl. CPC B25G 1/04

(57) ABSTRACT

A mechanically driven and battery powered extension pole for painting and construction tasks. The extendable pole includes an outer pole sheathing a linear actuator, an inner pole dimensioned and shaped to be telescopically received in the outer pole around the linear actuator, and a handle connected to a proximal end of the outer pole. The handle houses an electromotor assembly electrically coupled to the linear actuator for selectively moving the inner pole, telescopically relative to the outer pole, between one or more extended positions and one or more retracted positions.

### BACKGROUND OF THE INVENTION

The present invention relates to extension poles and, more particularly, to a mechanically driven and battery powered extension pole for painting and constructions tasks.

Painting is a key part of construction and renovation processes. Whether a structure is for residential or commercial use, painting the interior and exterior portions of the structure acts to provide a desired aesthetic to the structure as well as provide a potentially protective coating. However, many of the areas in or around a building that need paint, such as areas with tall walls or high ceilings, are often beyond a person's natural reach, and therefore incredibly difficult to paint. Conventional solutions involve ladders or lifting equipment that puts people into potentially dangerous positions, or manually extendable equipment that tends to get stuck or break. Further conventional solutions do not account for the varying levels of strength of different people, leading to many conventional solutions being uncomfortable to use and difficult to handle. This can lead to uneven and inefficient applications of paint, as well as potential injuries for the user.

As can be seen, there is a need for painting equipment that allows a user to reach and efficiently paint hard-to-reach places, such as tall walls or high ceilings, without putting the user in uncomfortable or dangerous positions. The present invention provides such a solution via a mechanically driven, battery-powered extension pole that is easy and comfortable to use, all while allowing for efficient painting in hard-to-reach areas.

### SUMMARY OF THE INVENTION

The present invention removes the need for a user to exert substantial force and to possess above-average physical strength and dexterity to paint hard-to-reach areas.

The present invention provides a strong and durable pole that is movable between an extended position and a retracted position at the push of a button to allow a user to paint difficult to reach areas easily.

In one aspect of the present invention, an extendable pole includes the following: an outer pole; a linear actuator sheathed in the outer pole; an inner pole dimensioned and shaped to be telescopically received in the outer pole; a handle connected to a proximal end of the outer pole; and an electromotor assembly housed in the handle, wherein the electro motor assembly is electrically coupled to the linear actuator for selectively moving the inner pole, telescopically relative to the outer pole, between one or more extended positions and one or more retracted positions.

In another aspect of the present invention, the extendable pole further includes wherein the linear actuator comprises a screw element centrally disposed within a lumen of the outer pole so that the inner pole rides along the screw element within said lumen as the inner pole linearly moves between the one or more extended positions and the one or more retracted positions; a nut assembly fixed to a proximal end of the inner pole and interlocked with the outer pole to prevent the nut assembly and inner pole from rotating with respect to the outer pole when moving between the one or more extended positions and the one or more retracted positions, wherein the nut assembly and screw element comprise a traveling-nut linear actuator for generating linear motion from rotation generated by the motor, a fastener connection at a distal end of the inner pole for removably connecting a tool thereto, wherein the electromotor assembly comprises a motor, a switch, a battery, and a control circuitry, wherein the switch protrudes out of the handle, and wherein the switch is movable between a deactivated state and an activated state powering the motor, and wherein the activated state comprises a extend condition and a retract condition rotating the screw element in a direction associated the one or more extended positions and the one or more retracted positions, respectively.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention.

FIG. 2 is an exploded perspective view of an exemplary embodiment of the present invention with handle 10 shown in hidden lines to illustrate interior features.

FIG. 3 is a detailed exploded perspective view of an exemplary embodiment of the present invention, taken along line 3-3 in FIG. 2, with drive screw 18 shown in hidden lines.

FIG. 4 is a section view of an exemplary embodiment of the present invention, taken along line 4-4 in FIG. 1.

FIG. 5 is a detailed section view of an exemplary embodiment of the present invention, taken along line 5 in FIG. 4, illustrating handle 10 with embedded parts.

FIG. 6 is a detailed section view of an exemplary embodiment of the present invention, taken along line 6 in FIG. 4, illustrating the movement of the middle pole 16 and nut assembly 14 as drive screw element/linear actuator 18 is turned by the motor 20.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a mechanically driven and battery powered extension pole for painting and constructions tasks. The present invention comprises at least one outer pole and at least one inner pole configured to telescopically cooperate with the outer pole. The present invention further comprises a battery assembly to provide power to the extension pole, a pulley assembly to selectively extend and retract the extension pole, a motor assembly to drive the pulley assembly, and a switch assembly to switch on power from the battery assembly to engage the motor assembly and operate the pulley assembly.

The battery assembly may further include a charger base, power supply connector jack, and battery pack. The switch assembly may include a rocker switch or other similarly functional button or switch. The pulley assembly may comprise a plurality of belts, including a short belt and a long belt. The short belt and long belt cooperate with one another via a set of pulley wheels that are spun by the motor assembly so that the short and long belts rotate and cause the extendable pole to extend or retract via the inner pole moving telescopically within respectively the outer tube.

In operation, when the switch assembly is placed in an activation position, the battery powers the motor assembly which engages the internal pulley system. The pulley system rotates the long belt. A belt clamp, which is locked onto the top of a shuttle, moves the shuttle as the pulley system is driven. The pulley system drives the shuttle back and forth along a pulley support rod until the shuttle contacts a limit switch at either end of the pulley support rod. As the pulley system drives the shuttle, the present invention is extended or retracted to a user's desired length.

It should be noted that the materials of manufacture for the present invention are not particularly limited. For example, the inner pole and outer tube may comprise any suitably durable and strong material, including, but not limited to, metals, such as aluminum, or plastics, such as, polyvinyl chloride (PVC) or acrylonitrile butadiene styrene (ABS) plastics. Further, the pulley system may comprise belts formed of suitably strong and mildly elastic materials, e.g., rubber or rubberized composites.

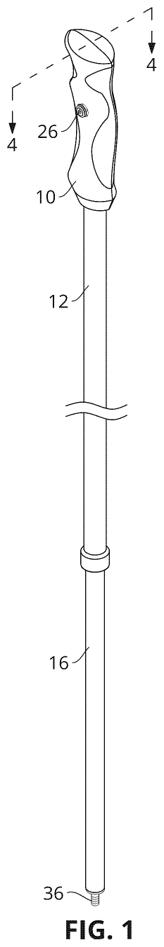

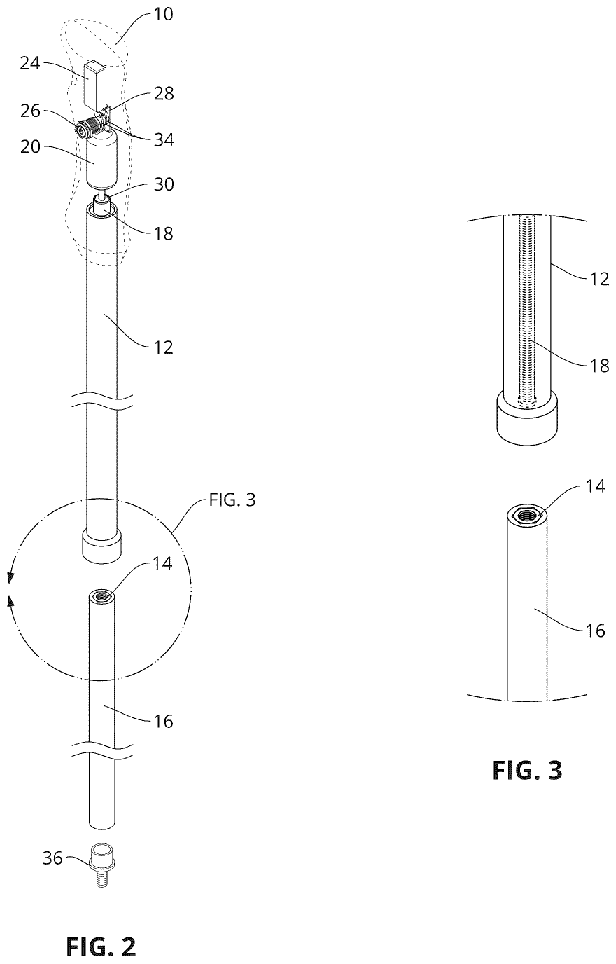

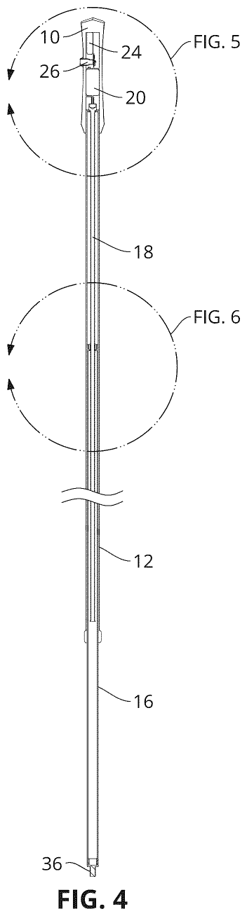

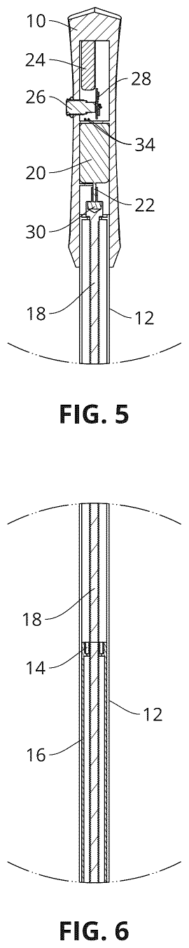

Referring now to FIGS. 1 through 6, an extendable pole 100 according to an embodiment of the present invention is shown. The extendable pole 100 may include an inner pole 16 and an outer pole 12 with the inner pole 16 configured to telescopically engage with and slide within the outer pole 12. The outer pole 12 may be tubular for enabling the inner pole 16 slidably associate therein. The inner pole 16 may or may not be tubular, i.e., it may or may not have a hollow cavity or lumen.

A linear actuator 18 may be sheathed in the outer pole 12 as it extends substantially the entire length of outer pole 12. The linear actuator 18 may include a screw element coupled to a motor 20. Along at least a proximal end of the inner pole 16, a nut assembly 14 may be interlocked with the outer pole 12 to prevent the nut assembly 14/inner pole 16 from rotating with respect to the outer pole 12. The screw element operatively associates with the nut assembly 14 so that as the screw element rotates while the nut assembly 14 and inner pole 16 do not. Thereby converting the rotary motion of the screw element, which is powered by a motor 20, to the linear movement of the inner pole 16 between the extended and retracted positions. In some embodiment, other linear actuators may be employed besides the traveling-nut linear actuator, whereby the inner pole 16 moves between a fully nested telescopic relationship with the outer pole 12 to a fully extended telescopic relationship with the outer pole 12.

The motor 20 may be housed in a handle housing 10 connected to a proximal end of the outer pole 12. The motor 20 may be part of an electro-mechanical power assembly including a batter 24, switch 26, and a printed circuit board (PCB) 28. The electro-mechanical power assembly transmits power to the screw element/linear actuator 18 through the coupler 30. The motor 20 is in mechanical communication with the coupler by way of a motor shaft 22.

The switch 26, which may include any suitable type of button, such as but not limited to a rocker switch, to control the extension and retraction of the extendable pole 100 by manipulating the handle 10, wherein the switch 26 protrudes out of the handle 10.

When the switch 26 is activated, the driving screw element/linear actuator 18 extends or retracts depending on which way the switch is pressed. Because the outer pole 12 is coupled to the driving screw element/linear actuator 18 via the nut assembly 14, the outer pole 12 serves as an external shroud for the driving screw element/linear actuator 18. The top end of the driving screw element/linear actuator 18 may have a screwed tool connection 26 for which a user can attach a tool to the invention. The screwed tool connection 36 is attached to inner pole 16 by a fastener.

Also, in the housing of the handle 10 the arrangement of the battery 24, switch assembly, and the motor assembly may be differently arranged than as shown in the appended Figures as they are all electrically connected by way of wiring 34. Moreover, an electrical arrangement that eliminates the need for a microelectronic circuit board and replaces it with a motor and power button configured to actuate forward and reverse movement of the inner pole 16 is contemplated by the present invention.

In operation, when the user presses the power button/switch 26 up or down, the extendable pole 100 extends or retracts, respectively, to the desired length to reach the intended/targeted area, by way of the inner pole 16 moving relative to the outer pole 12 between a fully extended position and fully nest position, respectively.

All the above components are essential for a simple form that is easy to manufacture at an economical cost. The poles 12, 16 that house the inner components of the present invention can be manufactured in a material that is least expensive or more expensive than what is specified. Material composition will dictate the weight of the invention and how easy it is to maneuver during use.

### Separate Embodiment

In a separate embodiment, a pulley assembly may be operatively associated with the inner and outer poles 16, 12 enabling the selective telescopic relative movement between the poles. A pulley support rod may be fitted inside the inner and outer poles 16, 12. A shuttle fits over the pulley support rod, and is configured to slide along the pulley support rod within the inner and outer tubes 16, 12. A micro limit switch may be mounted to each of a first end and second end of the pulley support rod, and is configured to engage with the shuttle when the shuttle is at one of the ends of the pulley support rod.

A toothed pulley may be fastened, e.g., via bolts, to a first plastic bracket. The toothed pulley may include any number of teeth and be formed of any material suitable to engage with a long belt of a pulley system housed within the inner and outer poles 16, 12. For example, the toothed plastic pulley may have a plurality of teeth and be formed of plastic. The first plastic bracket may be inserted into and mounted to the first end of the pulley support rod by known methodologies, such as bolts. A double pulley assembly may be fastened, e.g., via bolts, to a second plastic bracket. The second plastic bracket is mounted inside the second end of pulley support rod by known methodologies, such as bolts.

The long belt may include an attached belt clamp and loops over the double pulley assembly and toothed pulley. The belt clamp may sit within a notch formed in the top of the shuttle, creating a mechanical assembly capable of gliding back and forth in a straight line along a longitudinal axis of the pulley support rod. A motor assembly such as but not limited to a 12-volt direct current motor, mounts to a third bracket, with the third bracket being made of a strong durable material, such as metal. A motor pulley mounts onto a shaft of the motor assembly, and a short belt may transfer power from the motor assembly to the double pulley assembly, which in turn drives the long belt.

A battery assembly is electrically connected via electrical wiring to the motor assembly, a switch assembly, and the micro limit switches. Cable guides may hold the electrical wiring in place along the pulley support rod and prevent the electrical wiring from getting caught in any moving part. The inner pole 16 may be dimensioned and shaped to fit over the pulley support rod including all parts and assemblies attached to pulley support rod. The inner pole 16 may be coupled to the shuttle, for example via screws, onto a second end of the inner pole 16. A guide ring may be fastened, e.g., with screws, into a first end of the outer pole 12, and the outer pole 12 is dimensioned and shaped to slidably receive the inner pole 16, thereby housing all internal components of the present invention, such as the battery assembly at a second end of the outer pole 12.

A threaded attachment, formed of a hard material, such as plastic, may may be mounted to a first end of the inner pole 16, creating a male connection for attachable tools, such as painting tools. The switch assembly, which may include any suitable type of button or switch, such as a rocker switch, is mounted to a handle so that a user may use the switch assembly to control the extension and retraction of the extendable pole 100. The switch assembly may be housed in the handle, whereby the switch protrudes out of the handle.

In operation, the switch assembly provides a switch that is movable between an activated condition and a deactivated condition to engage and disengage, respectively, the battery assembly, thereby powering the motor assembly and turn the pulley system. The pulley system then rotates the long belt and the attached belt clamp, which is locked onto the top of the shuttle, thereby moving the shuttle as the long belt turns. The pulley system then drives the shuttle back and forth along the pulley support rod until the shuttle contacts one of the limit switches at either of the pulley support rod. As the pulley system drives the shuttle, the inner pole 16 telescopically slides into or out of the outer pole 12, such that the present invention is extended or retracted to a user's desired length.

In exemplary embodiments, the long and short belts may be formed of Kevlar™-reinforced rubber and have teeth configured to engage toothed pulley wheels. The long belt may be approximately 0.25 inches wide, approximately 0.06 inches thick, and approximately 44.35 inches long, and arranged to include looped ends that have approximately 0.71-inch radii. The short belt may be approximately 0.12 inches wide, approximately 0.03 inches thick, and approximately 1.5 inches long, and arranged to form a first looped end with an approximately 0.24-inch radius and a second opposing looped end with an approximately 0.37-inch radius. The shuttle may be circular, approximately 2.25 inch long with an approximately 1.84-inch diameter and have an approximately 0.8 inch by 0.8-inch square opening in its center.

In exemplary embodiments, the motor assembly may be an approximately 12-volt direct current (DC) motor with an operating speed of approximately 20 rpm. The motor pulley may have a suitable number of teeth, with an approximately 0.07-inch pitch, an approximately 0.24-inch bore, and an approximately 0.63-inch diameter hub that fits on the shaft of the motor assembly. Further, the third bracket may be a hollow and metal bracket with an open bottom and be approximately 3.63 inches in length and 0.92 in height. The toothed pulley may be formed of a strong material, such as aluminum, include scores of teeth, be approximately 0.63 inch thick with an approximately 0.31-inch bore.

In exemplary embodiments, the outer pole 12 may be approximately fifty-six inches long, have an approximately 2.25-inch diameter, and an approximately 0.13-inch wall thickness. The inner pole 16 may be approximately forty-eight inches long with a two-inch diameter, and a 0.13-inch wall thickness. The double pulley assembly 12 may be formed from a durable material, such as aluminum, and include a first pulley mated with a second pulley, wherein the first pulley has scores of teeth, is approximately 0.63 inches thick, and has an approximately 0.31-inch bore, and the second pulley has more than a dozen teeth, is approximately 0.64 inches thick, and is approximately 0.61 inches in diameter.

In exemplary embodiments, the first plastic bracket may be approximately 2.62 inches in length with an approximately 0.77-inch square opening in one end of the first plastic bracket and an approximately 0.5-inch-wide notched groove on top of the first plastic bracket. The second plastic bracket may be approximately 3.74 inches in length with an approximately 1.0-inch-long square tab on one end of the second plastic bracket with an approximately 0.2-inch-wide notched groove on top of the second plastic bracket. The pulley support rod may be formed of a strong durable material, such as aluminum, and may further be approximately forty-one inches long with an approximately 0.75 inch by approximately 0.75-inch square cross-section.

In exemplary embodiments, the belt clamp 21 may be formed from a durable material, such as aluminum, and may be approximately 1.57 inches long, approximately 0.35 inches wide, and approximately 0.33 inches in height. The limit switches 23 may be 5 amp, 125V/250V, single pole, double throw microswitches with a lever arm and 3 connector pins. The switch assembly may comprise a snap-in, panel mount, double-pole double-throw rocker switch rated for approximately sixteen amps and one hundred and twenty-five volts of alternating current (AC).

In exemplary embodiments, the battery assembly may be a 2600 mAH, 14.4-volt rechargeable lithium-ion battery with a two-prong connector, approximately 5.5×2.1 mm panel mounted DC power plug jack with female connection. The battery assembly may further include an ABS plastic interface between a battery and a charging base, which may also be made of plastic, such as ABS. The charging base may be approximately 4.2 inches long and approximately 2.25 inches in diameter. Additionally, the guide ring may be formed of a durable and strong material, such as steel, and be approximately 2.04 inches in inside diameter and approximately 0.23 inches thick. Alternatively, the battery assembly may include a rechargeable and removeable battery pack that can be inserted and snapped into place or removed at the press of a button. The removable, rechargeable battery pack can be charged on a dedicated battery charger and then reinserted into the invention after being fully charged. The cable guide may be of strong material, such as metal, and be a suitable size to fit within the inner and outer poles 16, 12 while holding the electrical wiring, for example approximately 0.81 inches long and approximately 0.58 inches wide.

Through such a construction, the present invention can provide a handheld, battery-powered, mechanically driven invention that extends and retracts to desired lengths at the press of a button. The present invention thus removes the requirement for intense human force and extensive physical strength when painting hard-to-reach areas. It allows all humans to paint high areas regardless comfortably and efficiently of their physical strength level or physical limitations.

### Another Embodiment

Handle 10 is the base and contains the electro-mechanical power assembly, including the motor 20, the power source 24, the power button 26, and control circuitry 28, wherein the power source provides the power for the device and connects to the control circuitry 28. The power source 24 is wired to the control circuitry 28 and the power button 26 that controls the device is connected to the control circuitry 28. The motor 20, power source 26, and the power button 26 all tie in together on the control circuitry 28 The shaft 22 of the motor 20 contains a coupler 30 that connects the motor 20 to the driving screw 18.

The driving screw 18 is housed by the outer pole 12. The inner pole 16 has a locking hex nut 14 on one end that couples with the end of the driving screw 18. The driving screw 18 is also housed by the inner pole 16. Inner pole 16 has a tool connection mounted at the end with a fastener.

The handle 10 contains the electro-mechanical power assembly wherein the power is transmitted to the driving screw 18 through the coupler 30. When the power button 26 is pressed up or down, the driving screw 18 extends or retracts depending on which way power button 26 is pressed. The inner pole 16 is coupled to the driving screw 18 via the hex nut 14 and serves as an external shroud for the driving screw 18. The top end of the driving screw 18 has a screwed tool connection for which a user can attach a tool to the invention. The screwed tool connection is attached to pole inner pole 16 by a fastener, such as a screw.

The only items in this embodiment that can be interchanged are the items that comprise the electro-mechanical power assembly for the invention. The power source (e.g., battery) 24 and motor 20 can be replaced with higher rated elements that would alter the power and speed of the invention. The items that comprise the electro-mechanical power assembly could be replaced with an electrical arrangement that eliminates the need for a microelectronic circuit board and replaces it with a motor and power button that can selectively drive in a forward and a reverse direction. The poles that house the inner components pf the invention can be manufactured in a material that is least expensive or more expensive than what is specified. Material composition will dictate the weight of the invention and how easy it is to maneuver during use.

When the user presses the power button 26 up or down, the invention extends or retracts the invention to the desired length to reach the intended/targeted area.

The items that comprise the electro-mechanical power assembly off-the-shelf parts that can be purchased. All other items would need to be manufactured according to the specifications on the design drawings.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. An extendable pole comprising an outer pole;
a linear actuator sheathed in the outer pole;
an inner pole dimensioned and shaped to be telescopically received in the outer pole;
a handle connected to a proximal end of the outer pole; and
an electromotor assembly housed in the handle, wherein the electro motor assembly is electrically coupled to the linear actuator for selectively moving the inner pole, telescopically relative to the outer pole, between one or more extended positions and one or more retracted positions.

2. The extendable pole of claim 1, wherein the linear actuator comprises a screw element centrally disposed within a lumen of the outer pole so that the inner pole rides along the screw element within said lumen as the inner pole linearly moves between the one or more extended positions and the one or more retracted positions.

3. The extendable pole of claim 2, further comprising a nut assembly fixed to a proximal end of the inner pole and interlocked with the outer pole to prevent the nut assembly and inner pole from rotating with respect to the outer pole when moving between the one or more extended positions and the one or more retracted positions.

4. The extendable pole of claim 3, wherein the nut assembly and screw element comprise a traveling-nut linear actuator for generating linear motion from rotation generated by the motor.

5. The extendable pole of claim 4, a fastener connection at a distal end of the inner pole for removably connecting a tool thereto.

6. The extendable pole of claim 5, wherein the electromotor assembly comprises a motor, a switch, a battery, and a control circuitry.

7. The extendable pole of claim 6, wherein the switch protrudes out of the handle, and wherein the switch is movable between a deactivated state and an activated state powering the motor.

8. The extendable pole of claim 7, wherein the activated state comprises a extend condition and a retract condition rotating the screw element in a direction associated the one or more extended positions and the one or more retracted positions, respectively.
